(19) United States
(12) Patent Application Publication
(10) Pub. No.: US 2026/0056513 A1
(43) Pub. Date: Feb. 26, 2026

(54) COMPENSATION FOR COORDINATED UNIVERSAL TIME SERVICE DISRUPTION IN AIRCRAFT OR OTHER SYSTEM

(71) Applicant: Hamilton Sundstrand Corporation, Charlotte, NC (US)

(72) Inventors: Qiuming Leng, South Barrington, IL (US); Paul J. Peterson, Rockford, IL (US)

(21) Appl. No.: 18/815,513

(22) Filed: Aug. 26, 2024

(51) Int. Cl. G04R 20/02; G07C 5/08

(52) U.S. Cl. CPC G04R 20/02; G07C 5/0816; G07C 5/085

(57) ABSTRACT

A method includes determining, by at least one processor, whether a Coordinated Universal Time (UTC) service is communicatively coupled to a communication interface. The method also includes setting a UTC time with (i) a standard UTC time received from the UTC time service or (ii) a local UTC time calculated based on an oscillator frequency of a timer mechanism associated with the at least one processor based on a determination result of whether the UTC time service is communicatively coupled to the communication interface.

### TECHNICAL FIELD

This disclosure relates generally to aircraft systems. More specifically, this disclosure relates to compensation for Coordinated Universal Time (UTC) service disruption in aircraft or other system.

### BACKGROUND

A fault occurs in an aircraft system or subsystem when a component in the subsystem malfunctions. Typically, the fault and its Coordinated Universal Time (UTC) timestamp is logged in a memory for storage, where the timestamp identifies a standard UTC time at which the fault occurred. For instance, a fault may occur in an electric subsystem when a generator oil level is low. The generator low oil level fault, along with the UTC timestamp at which the fault is detected, can be logged in a non-volatile memory (NVM) as a fault record that is used in maintenance and system troubleshooting.

### SUMMARY

This disclosure relates to compensation for Coordinated Universal Time (UTC) service disruption in aircraft or other system.

In a first embodiment, a method may include determining, by at least one processor, whether a UTC time service is communicatively coupled to a communication interface. The method may also include setting the UTC time with (i) a standard UTC time received from the UTC time service or (ii) a local UTC time calculated based on an oscillator frequency of a timer mechanism associated with the at least one processor based on a determination result of whether the UTC time service is communicatively coupled to the communication interface.

In a second embodiment, an electronic device may include at least one processor and a communication interface. The communication interface may be configured to communicatively couple to a UTC time service. The at least one processor may be configured to determine whether the UTC time service is communicatively coupled to the communication interface. The at least one processor may also be configured to set the UTC time with (i) a standard UTC time received from the UTC time service or (ii) a local UTC time calculated based on an oscillator frequency of a timer mechanism associated with the at least one processor based on a determination result of whether the UTC time service is communicatively coupled to the communication interface.

In a third embodiment, a non-transitory machine-readable medium may include instructions that when executed cause at least one processor to determine whether a UTC time service is communicatively coupled to a communication interface. The non-transitory machine-readable medium may also include instructions that when executed cause the at least one processor to set the UTC time with (i) a standard UTC time received from the UTC time service or (ii) a local UTC time calculated based on an oscillator frequency of a timer mechanism associated with the at least one processor. The instructions that when executed cause the at least one processor to set the UTC time may include instructions that when executed cause the at least one processor to set the UTC time based on a determination result of whether the UTC time service is communicatively coupled to the communication interface.

Any single one or any combination of the following features may be used with the first, second, or third embodiment. The UTC time may be set with the local UTC time in response to a determination that the UTC time service is disconnected from the communication interface. The UTC time may be set with the received standard UTC time in response to a determination that the UTC time service is connected to the communication interface.

A fault in an aircraft system or subsystem may be detected while the UTC time service is disconnected from the communication interface. A fault record may include a timestamp of the local UTC time at which the detection of the fault occurred and may be logged into a non-volatile memory (NVM).

Calibration of a local UTC clock may be performed while the UTC time service is communicatively coupled to the communication interface. The calibration of the local UTC clock may include counting each tick of a periodic timer interrupt that occurs periodically every timer interrupt interval. Each tick may be defined by a number of oscillations of the timer mechanism during the periodic timer interrupt interval. The calibration of the local UTC clock may include counting each second of standard UTC time that elapses during the counting of the ticks until the seconds counted satisfies a time threshold for writing into the non-volatile memory. The calibration of the local UTC clock may include writing a calibration data pair into the non-volatile memory. The calibration data pair may include (i) the ticks counted during the seconds elapsed and (ii) the seconds elapsed that satisfied the time threshold.

Calculation of the local UTC time may include starting a local UTC clock in response to a determination that the UTC time service is connected to the communication interface. As part of calculating the local UTC time, each tick in response to the periodic timer interrupt may be counted after the start of the local UTC clock. Seconds elapsed of the local UTC time may be determined as an estimated equivalent to seconds elapsed of standard UTC time based on a count of the ticks counted since the start of the local UTC clock divided by a scale ratio. The scale ratio represents a calibrated number of ticks in a second, wherein the scale ratio is deduced from a previously calibrated data pair read from a non-volatile memory (NVM) at system startup or a fresh calibrated data pair to write into the NVM at a calibration time. The calculation of the local UTC time may include counting each elapsed second of the local UTC time since the start of the local UTC clock to update the calculated local UTC time.

Other technical features may be readily apparent to one skilled in the art from the following figures, descriptions, and claims.

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example aircraft supporting compensation for Coordinated Universal Time (UTC) service disruption on an aircraft system or subsystem to extend the time service according to this disclosure;

FIG. 2 illustrates an example computing device or system supporting compensation for UTC time service disruption on an aircraft system or subsystem to extend time service according to this disclosure;

FIG. 3 illustrates an example UTC time handler initialization method according to this disclosure;

FIG. 4 illustrates an example UTC time handler method according to this disclosure;

FIG. 5 illustrates an example local clock calibration method according to this disclosure;

FIG. 6 illustrates an example local UTC time calculation method according to this disclosure;

FIG. 7 illustrates an example method for setting the local UTC time according to this disclosure;

FIG. 8 illustrates an example method for restarting the local UTC time according to this disclosure; and

FIG. 9 illustrates an example method for implementing compensation for UTC time service disruption to extend time service according to this disclosure.

### DETAILED DESCRIPTION

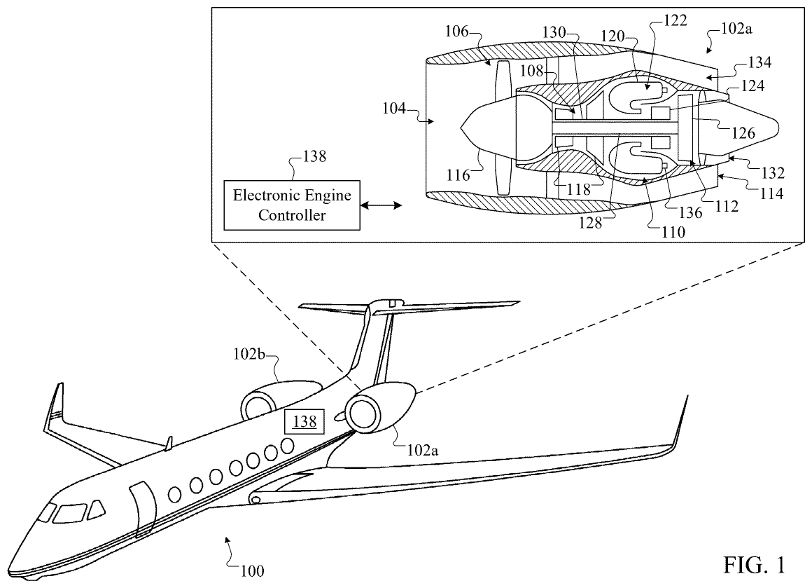

FIGS. 1 through 9, described below, and the various embodiments used to describe the principles of the present disclosure are by way of illustration only and should not be construed in any way to limit the scope of this disclosure. Those skilled in the art will understand that the principles of the present disclosure may be implemented in any type of suitably arranged device or system.

As noted above, a fault occurs in an aircraft system or subsystem when a component in the subsystem malfunctions. Typically, the fault and its Coordinated Universal Time (UTC) timestamp is logged in a memory for storage, where the timestamp identifies a standard UTC time at which the fault occurred. For instance, a fault may occur in an electric subsystem when a generator oil level is low. The generator low oil level fault, along with the UTC timestamp at which the fault is detected, can be logged in a non-volatile memory (NVM) as a fault record that is used in maintenance and system troubleshooting.

An aircraft may obtain time information from a Global Navigation Satellite System (GNSS) service, such as from a Global Positioning System (GPS) service. Standard UTC time may be deduced from the GNSS time and broadcast to the aircraft's systems and subsystems through the aircraft's data communication networks. Logging fault records with incorrect timestamps is a problem when the standard UTC time is unavailable or cannot be broadcast via the aircraft's data communication networks, such as when the aircraft cannot receive communication from a GNSS/GPS satellite. Each logged fault record also includes a default timestamp while standard UTC time is unavailable to the aircraft. In some aircraft, the default timestamp is a previously known standard UTC time, such as the time at which the aircraft lost communication from the GNSS/GPS satellite. In other aircraft, the default timestamp is an arbitrary value, such as 1970 Jan. 1-00:00:00 (indicating midnight on Jan. 1, 1970).

An aircraft can be negatively impacted by a UTC time service disruption that occurs when loss of communication affects an aircraft system or subsystem. For instance, when UTC time service disruption occurs, an electric generator control box cannot obtain its UTC time service, and subsequent faults affecting the electric generator control box are logged without correct timestamps. As a result, it becomes arduous to perform maintenance and fault troubleshooting. Embodiments of this disclosure provide compensation for UTC time service disruption in aircraft or other systems that can help to overcome these or other issues involving loss of UTC time. For example, embodiments of this disclosure can provide a calibrated precise local UTC clock to extend UTC time service when the standard UTC time service is disrupted.

FIG. 1 illustrates an example aircraft 100 supporting compensation for UTC time service disruption on an aircraft system or subsystem to extend time service according to this disclosure. As shown in FIG. 1, the aircraft 100 represents an airplane having multiple engines 102a-102b, where at least one engine 102a is positioned on one side of the aircraft 100 and at least one engine 102b is positioned on the opposite side of the aircraft 100. Note that the form of the aircraft 100 shown in FIG. 1 is for illustration only and that the aircraft 100 may have any other suitable form. As one example, the engines 102a-102b of the aircraft 100 may be positioned on the wings of the aircraft 100 rather than towards the rear of the aircraft 100. As another example, while the aircraft 100 in this example has two engines 102a-102b, the aircraft 100 may have any other numbers of engines, such as when two or more engines are positioned on each side of the aircraft 100.

As described in more detail below, the engines 102a-102b can be associated with an electronic engine controls (EEC) system or a flight management system (FMS) (EEC/FMS) 104 of the aircraft 100. The EEC/FMS 104 may be implemented using one or more processing devices, such as one or more microprocessors, microcontrollers, digital signal processors (DSPs), application specific integrated circuits (ASICs), field programmable gate arrays (FPGAs), or discrete circuitry. This disclosure does not limit the EEC/FMS 104 to any particular type of device or system. In some embodiments, the EEC/FMS 104 may communicate with and use a UTC time service through a communication interface to receive input from the UTC time service. Note, however, that any other system or subsystem of the aircraft 100 may communicate with and use the UTC time service through the communication interface.

Although FIG. 1 illustrates one example of an aircraft 100 supporting compensation for UTC time service disruption on an aircraft system or subsystem to extend time service, various changes may be made to FIG. 1. For example, as noted above, the form of the aircraft 100 and the positions of the engines 102a-102b on the aircraft 100 can vary depending on the implementation. Also, any suitable system or subsystem of the aircraft 100 may benefit from or use the disclosed techniques for compensation for UTC time service disruption.

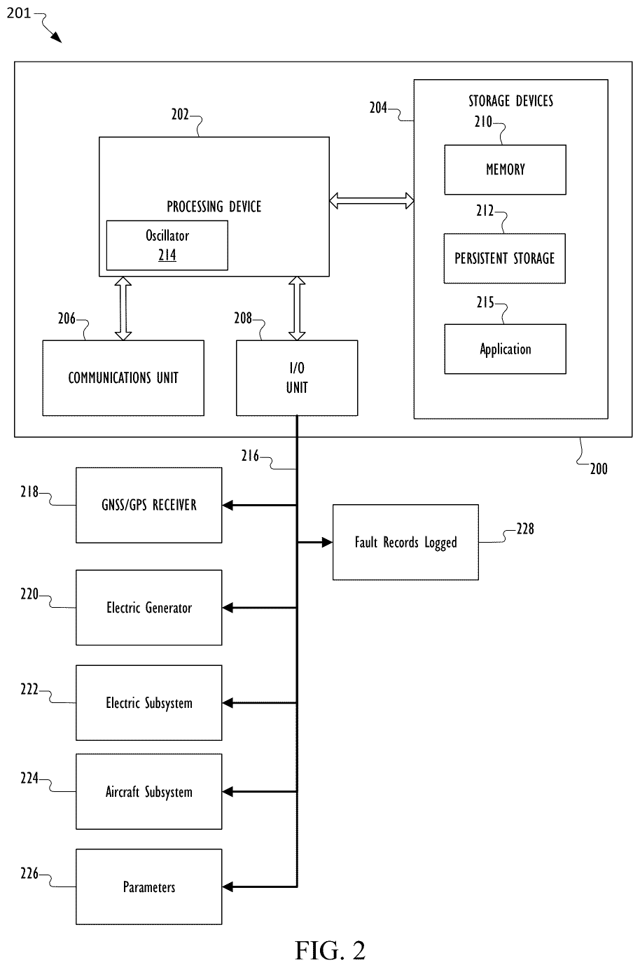

FIG. 2 illustrates an example computing device or system 200 supporting compensation for UTC time service disruption on an aircraft system or subsystem to extend the time service according to this disclosure. In some embodiments, the computing device or system 200 can include or represent the EEC/FMS 104 in the aircraft 100 of FIG. 1.

As shown in FIG. 2, the computing device or system 200 may include at least one processing device 202, at least one optional storage device 204, at least one communications unit 206, and at least one optional input/output (I/O) unit 208. The processing device 202 may execute instructions that can be loaded into a memory 210 or other location that is local to the processing device 202. The processing device 202 includes any suitable number(s) and type(s) of processors or other processing devices in any suitable arrangement. Example types of processing devices 202 include one or more microprocessors, microcontrollers, DSPs, ASICs, FPGAs, or discrete circuitry.

The memory 210 and a persistent storage 212 are examples of storage devices 204, which represent any structure(s) capable of storing and facilitating retrieval of information (such as data, program code, and/or other suitable information on a temporary or permanent basis). The memory 210 may represent a random access memory or any other suitable volatile or non-volatile storage device(s). The persistent storage 212 may contain one or more components or devices supporting longer-term storage of data, such as a read only memory, hard drive, Flash memory, or optical disc.

The communications unit 206 supports communications with other systems or devices. The communications unit 206 may support communications through any suitable physical or wireless communication link(s), such as a network or dedicated connection(s). The communications unit 206 can be a communication interface in an aircraft subsystem, communicating with the aircraft system or other subsystems.

The I/O unit 208 allows for input and output of data. For example, the I/O unit 208 may provide a connection for user input through a keyboard, mouse, keypad, touchscreen, or other suitable input device. The I/O unit 208 may also send output to a display or other suitable output device. Note, however, that the I/O unit 208 may be omitted if the device or system 200 does not require local I/O, such as when the device or system 200 represents a server or other component that can be accessed remotely over a network.

In some embodiments, the processing device 202 may include a timer mechanism, such as an oscillator 214, for supplying one or more clock signals. The oscillator 214 can be a built-in oscillator in the processing device 202 or can be an external oscillator in case the processing device 202 does not include a built-in oscillator. The frequency of the oscillator 214 can be used to keep track of time and to provide a stable clock signal for the processing device 202. In some cases, the oscillator 214 may represent a crystal oscillator that generates a time pulse as a timekeeper or that is used by a timer module to generate a time tick. The crystal oscillator can oscillate at a reasonably stable resonant frequency. Note, however, that this disclosure is not limited to any specific type of timer mechanism, and other types of suitable timer mechanisms can be used, such as various piezoelectric materials. Also, in some embodiments, the storage device 204 can store one or more applications 215 that can be executed by the processing device 202. The application(s) 215, when executed, can enable the device or system 200 to perform various functions for compensating for UTC time service disruption as described below. In addition, in some embodiments, the I/O unit 208 can interface with a data bus, such as an aircraft data communication network 216. In this way, the computing device or system 200 may connect to and communicate with one or more external devices or systems, such as one or more subsystems. For instance, the I/O unit 208 may interface with a GNSS/GPS receiver 218 that obtains GNSS/GPS time from a satellite service, a Maintenance and Diagnostics system 220 or other component of a maintenance subsystem, an electric subsystem 222, or other aircraft subsystems such as a data concentrator unit (DCU) 224.

In this example, the application 215 may include or access various parameters 226 that store parameter values. The parameters 226 can be stored internally within the storage devices 204 or externally in an external storage device. For ease of illustration, the parameters 226 are depicted as being stored in an external storage device. The aircraft subsystems 220-224 can also write logs into a non-volatile memory (NVM), such as by logging one or more fault records 228. The fault records 228 can be stored internally within the storage devices 204 or externally in an external storage device. For ease of illustration, the fault records 228 are depicted as being stored in an external storage device.

Typically, a fault record in a subsystem is logged in the subsystem. For example, when a fault occurs in the electric system, the fault is logged in the NVM in the electric system. A fault detected by a processing device is typically logged in the NVM that is local to the processing device. Part of the fault information (excluding timestamp) then may be sent to the Maintenance and Diagnostics system 220. The maintenance subsystem, including the Maintenance and Diagnostics system 220, may include NVM to store fault records attached with its perceived UTC timestamps.

The DCU 224 collects avionics data and makes the avionics data or computed data available to the subsystems on the data communication network 216. The DCU 224 can collect and make the parameters 226 and fault records logged 228 accessible via the data communication network 216.

Although FIG. 2 illustrates one example of a computing device or system 200 supporting compensation for UTC time service disruption on an aircraft system or subsystem to extend time service according to this disclosure, various changes may be made to FIG. 2. For example, computing devices and systems come in a wide variety of configurations, and FIG. 2 does not limit this disclosure to any particular computing device or system.

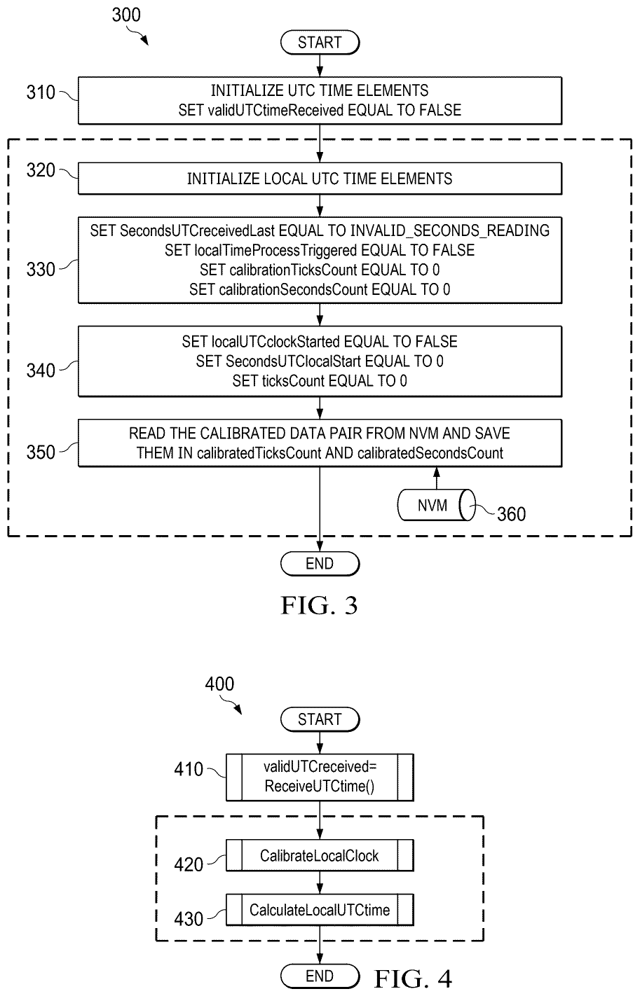

FIG. 3 illustrates an example of UTC time handler initialization method 300 according to this disclosure. The UTC time handler initialization method 300 can be performed to initialize UTC time elements, a UTC time receive status, local UTC clock time and the local UTC clock status. For ease of explanation, the UTC time handler initialization method 300 will be described as performed using the computing device or system 200 of FIG. 2 within the aircraft 100 of FIG. 1. However, the UTC time handler initialization method 300 may be performed using any other suitable device(s) or system(s).

Refer temporarily to FIGS. 3 and 4. This disclosure includes the procedures in the “UTC Time Handler Initialization” method 300 (depicted in FIG. 3) and the procedures in the “UTC Time Handler” method 400 (depicted in FIG. 4). The procedures in the “UTC Time Handler Initialization” method 300 are executed only once at the system startup. The procedures in the “UTC Time Handler” method 400 (in FIG. 4) are executed periodically. The “UTC Time Handler” method 400 may be placed in a periodic software task driven by a periodic interrupt with a suitable period, such as 5 milliseconds. The “UTC Time Handler” method 400 (depicted in FIG. 4) is composed of the UTC time receiving module (block 410), local clock calibration module (block 420) and local UTC time calculation module (block 430). The UTC time receive status (TRUE/FALSE) in block 410 determines the connection status (CONNECTED/DISCONNECTED) to the UTC time service. The local clock calibration is active when the device is CONNECTED to the UTC time service. The local clock calibration is in reset state when the device is DISCONNECTED to the UTC time service. The local UTC time calculation starts after seconds reading change in the received UTC time from CONNECTED UTC time service, which is significant because the local UTC clock needs a relatively accurate UTC time reference. Once the local UTC clock starts, the local UTC clock keeps running. On the other hand, the local UTC clock never starts if the device is never CONNECTED to the UTC time service or is CONNECTED to the UTC time service briefly without a change to the seconds reading in the received UTC time from CONNECTED UTC time service. When the device is CONNECTED to the UTC time service, the UTC time parameters used by the device are set with the received UTC time. When the device is DISCONNECTED from the UTC time service, the UTC time parameters used by the device are set with the time from local UTC clock if the local UTC clock is running, otherwise the UTC time parameters are set with their default values. The term “UTC time parameters” can mean UTC time variables used by a device. The “UTC time parameters” may be set with the received UTC time in case of CONNECTED service or the local UTC time if the local clock is running. In this disclosure, “local UTC time” refers to the time read from a local UTC clock.

Now refer to FIG. 3. Block 310 represents a process to initialize the UTC time elements and the UTC time receive status, which in some cases may be performed using known techniques. For example, a validUTCtimeReceived parameter can be set to FALSE as shown in Table 1 below. The validUTCtimeReceived parameter can be a flag set to TRUE or FALSE. More particularly, the validUTCtimeReceived can be a flag to indicate whether the received UTC time is valid and can be set to TRUE at receiving a set of valid UTC time elements and can be set FALSE otherwise. The FALSE value of the validUTCtimeReceived parameter can be used to indicate that the processing device 202 has not recently received a valid UTC time from a UTC time service. In some instances, validUTCtimeReceived parameter can be FALSE to indicate that the UTC time service is disconnected, indicating that the UTC time is not being received. The validUTCtimeReceived parameter value can be FALSE during a fault that disrupts the UTC time service. The flag can be set to a TRUE value while the UTC time service is connected. Table 2 below shows the UTC time elements that may be initialized and used for denoting the UTC time.

TABLE 1
Initial values of parameters associated
with UTC time receive status

| Parameter Name | Parameter Value |
|---|---|
| validUTCtimeReceived | FALSE |

TABLE 2
Initial values of parameters associated
with standard UTC time elements

| Parameter Name | Parameter Value |
|---|---|
| SecondsUTC | UTC seconds initial value. |
| MinutesUTC | UTC minutes initial value. |
| HoursUTC | UTC hours initial value. |
| DaysUTC | UTC days initial value. |
| MonthsUTC | UTC months initial value. |
| YearsUTC | UTC years initial value. |

An updated UTC time handler initialization also includes blocks 320-350 and a non-volatile memory (NVM) 360. At block 320, the processing device 202 can initialize local UTC time elements. Table 3 below shows the UTC time elements that can be initialized and used for denoting the local UTC time. To initialize a local UTC time setting, parameters of year, month, day, hour, minute, and seconds may be set as zero.

TABLE 3
Initial values of parameters associated
with Local UTC time elements

| Parameter Name | Parameter Value |
|---|---|
| SecondsUTClocal | 0 |
| MinutesUTClocal | 0 |
| HoursUTClocal | 0 |
| DaysUTClocal | 0 |
| MonthsUTClocal | 0 |
| YearsUTClocal | 0 |

At block 330, the processing device 202 can set initial values for parameters associated with configuring a local clock calibration as shown in Table 4 below.

TABLE 4
Initial values of parameters associated with
configuration of a local clock calibration

| Parameter Name | Parameter Value |
|---|---|
| SecondsUTCreceivedLast | INVALID_SECONDS_READING |
| localTimeProcessTriggered | FALSE |
| calibrationTicksCount | 0 |
| calibrationSecondsCount | 0 |

At block 340, the processing device 202 can set initial values for parameters associated with status of the local UTC clock as shown in Table 5 below.

TABLE 5
Values of parameters associated with status of the local UTC clock

| Parameter Name | Parameter Value |
|---|---|
| localUTCclockStarted | FALSE |
| SecondsUTClocalStart | 0 |
| ticksCount | 0 |

At block 350, the processing device 202 can read a calibrated data pair from the NVM 360 and save the pair in the calibratedTicksCount and calibratedSecondsCount in local storage of the processing device as shown in Table 6 below. The NVM 360 can store at least some (if not all) parameters 226 and can be part of the storage devices 204 of FIG. 2. The calibrated data pair read from the NVM 360 can be a calibrated data pair from a previous calibration process, and used for the local UTC time calculation.

TABLE 6
Type of values stored in parameters associated
with a Calibrated Data Pair

| Parameter Name | Type of Value |
|---|---|
| calibratedTicksCount | Numerical |
| calibratedSecondsCount | Numerical |

FIG. 4 illustrates an UTC time handler method 400 according to this disclosure. The UTC time handler method 400 can be performed to receive a standard UTC time via a communication interface. For ease of explanation, the UTC time handler method 400 will be described as performed using the computing device or system 200 of FIG. 2 within the aircraft 100 of FIG. 1. However, the UTC time handler method 400 may be performed using any other suitable device(s) or system(s).

At block 410, an update to the value of the validUTCtimeReceived parameter can occur. More particularly, block 410 can represent a ReceiveUTCtime subprocess that includes a procedure to receive a standard UTC time via the communication interface, which in some cases may be performed using known techniques. The UTC time service can send (such as via a broadcast transmission) values for the UTC time elements, which can be received via the communication interface and assigned values in this ReceiveUTCtime subprocess as shown in Table 7 below. Table 7 includes the same parameter names as Table 2, but the parameter values in Table 7 are updated based on the values received from the UTC time service and read by the processing device 202. The validUTCtimeReceived parameter value can be updated to indicate the received UTC time is valid and set to TRUE at receiving a set of valid UTC time elements. In response to receiving a set of UTC time elements that are not valid, the validUTCtimeReceived parameter value can be updated to indicate the received UTC time is not valid and set to FALSE. In some embodiments, the validUTCtimeReceived parameter value can be updated to indicate the received UTC time is not valid and set to FALSE in response to a UTC time receiving timeout event occurrence. When a communication device (such as the communication unit 206) has not received a standard UTC time from the UTC time service for a predetermined period (such as a prolonged period), a timeout for receiving standard UTC time has occurred. For example, the processing device 202 may be designed to receive (or expect to receive) standard UTC time from the UTC time service once every 100 milliseconds. If standard UTC time has not been received for a prolonged period (for example, a duration of 300 milliseconds), a timeout event has occurred.

TABLE 7
Received values of parameters associated
with standard UTC time elements

| Parameter Name | Parameter Value |
|---|---|
| SecondsUTC | UTC seconds reading. |
| MinutesUTC | UTC minutes reading. |
| HoursUTC | UTC hours reading. |
| DaysUTC | UTC days reading. |
| MonthsUTC | UTC months reading. |
| YearsUTC | UTC years reading. |

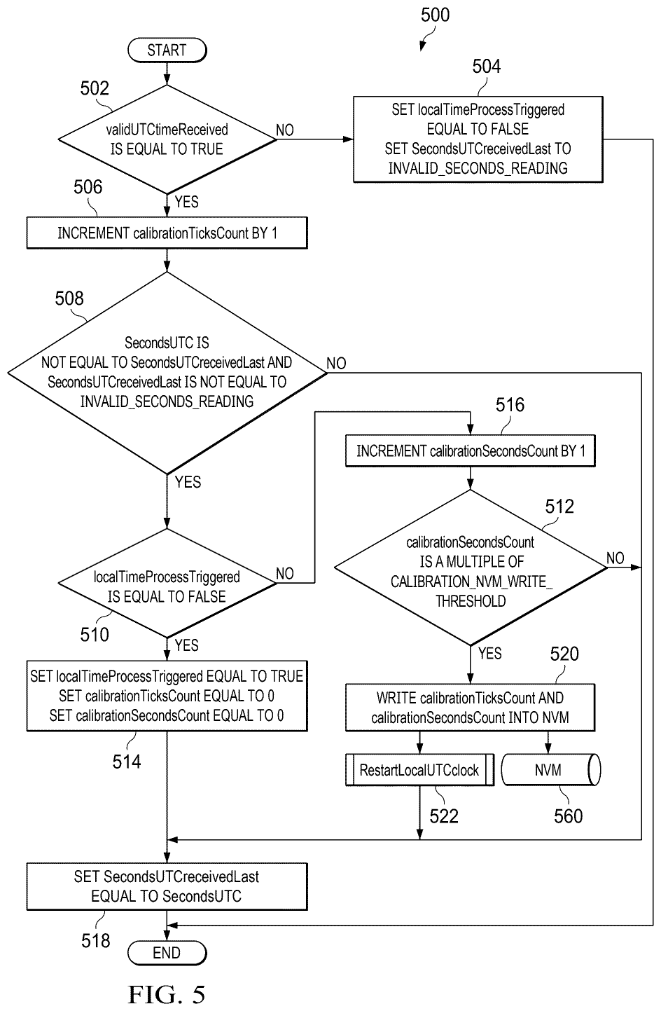

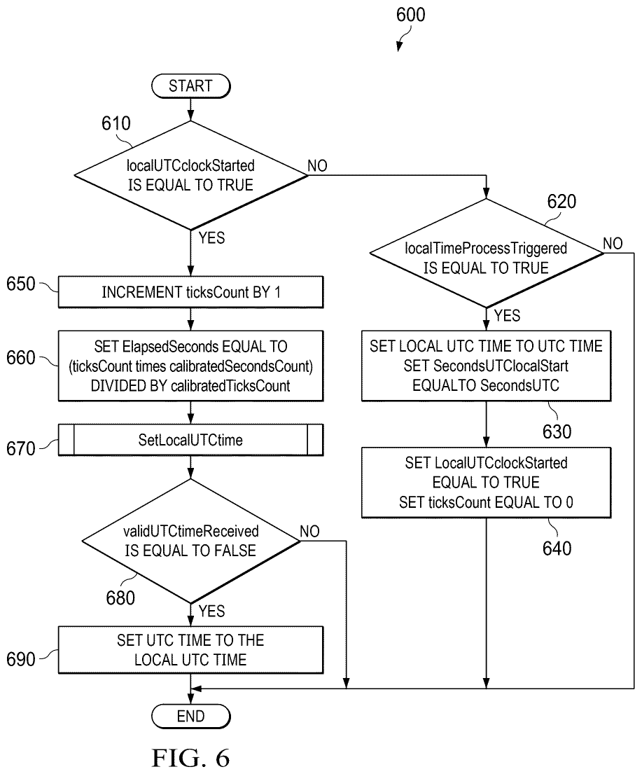

An updated UTC Time Handler can also include blocks 420-430. The method 400 can include two more subprocesses, such as a CalibrateLocalClock subprocess 420 and a CalculateLocalUTCtime subprocess 430. In some embodiments, the CalibrateLocalClock subprocess 420 can be implemented using the local clock calibration method 500 of FIG. 5 as described below. Also, the CalculateLocalUTCtime subprocess 430 can be implemented using the local UTC time calculation method 600 of FIG. 6 as described below.

Although FIG. 3 illustrates one example of a UTC time handler initialization method 300 and FIG. 4 illustrates one example of a UTC time handler method 400, various changes may be made to FIGS. 3 and 4. For example, the specific parameters and values described above are examples only and can vary depending on the specific implementation.

FIG. 5 illustrates an example of local clock calibration method 500 according to this disclosure. The local clock calibration method 500 can be performed to calibrate a local clock relative to a received standard UTC time. For ease of explanation, the local clock calibration method 500 will be described as performed using the computing device or system 200 of FIG. 2 within the aircraft 100 of FIG. 1. However, the local clock calibration method 500 may be performed using any other suitable device(s) or system(s). In this example, the local clock calibration method 500 is shown as involving the use of an NVM 560, which could be the same as or similar to the NVM 360 of FIG. 3.

In some embodiments, the local clock calibration method 500 may only be performed while the UTC time service is available to communicate standard UTC time to the computing device or system 200. As part of performing the local clock calibration method 500, the processing device 202 can count system ticks while keeping track of the elapsed time in standard UTC time. In this disclosure, a system tick is also referred to as a “tick.” When the elapsed time is large enough, the system ticks count and the elapsed time in seconds are written in the NVM 560 as a calibrated data pair relative to the received standard UTC time. As an example, the processing device 202 may determine that the elapsed time is large enough if greater than or equal to a predetermined value. In some embodiments, the predetermined value is a multiple of a threshold value, which could be denoted CALIBRATION_NVM_WRITE_THRESHOLD. In some cases, this threshold may be 3,600 seconds. The local UTC clock may restart to synchronize the local UTC clock with the received standard UTC time and utilize the fresh calibrated data pair. When the calibrated system ticks count over the elapsed UTC time is large enough (such as 720,050 ticks over 3,600 elapsed seconds), a precise local UTC clock can be built from the calibrated pair and the free-running system ticks count. The calibrated pair can also be stored in the NVM 560 and restored at system startup.

The local clock calibration method 500 can provide local UTC clock calibration against the received UTC time. The parameters used in method 500 can include the entirety of the parameters of Table 1 and Table 4 above, the SecondsUTC parameter from Table 2, and the CALIBRATION_NVM_WRITE_THRESHOLD threshold value parameter. The calibrationTicksCount parameter can denote the accumulated system ticks count since the start of the local UTC clock calibration, such as when the calibrationTicksCount parameter is set to zero at sensing the first UTC seconds reading change and is incremented by one with every system tick. The calibrationSecondsCount parameter can denote the accumulated seconds count since the start of the local UTC clock calibration, such as when the calibrationSecondsCount parameter is set to zero at sensing the first UTC seconds reading change and is incremented by one with every elapsed UTC second. The SecondsUTCreceivedLast parameter can denote the UTC seconds reading in the last system tick cycle, such as when the SecondsUTCreceivedLast parameter is compared to UTC seconds reading in the current system tick cycle to determine whether the UTC seconds reading has just changed. At system startup or UTC time service disruption, the SecondsUTCreceivedLast parameter can be set to INVALID_SECONDS_READING, such as a value of 100. The localTimeProcessTriggered parameter can be a flag to indicate whether the local time processing has triggered, such as when the localTimeProcessTriggered parameter is set to FALSE at the system startup or UTC time service disruption and is set to TRUE when the UTC seconds reading changes the first time after UTC time service starts. The localTimeProcessTriggered parameter can be set to TRUE when the UTC seconds reading changes the first time after UTC restarts following a UTC time service disruption. For simplicity and precision, at sensing the first UTC seconds reading change after the UTC time service starts or restarts following a service disruption, the calibration data pair (the calibrationTicksCount and calibrationSecondsCount parameters) can be set to zero to start/restart the calibration process.

At block 502, the processing device 202 can determine whether the value of the validUTCtimeReceived parameter is equal to TRUE. The method 500 proceeds to block 504 based on a determination that the validUTCtimeReceived parameter is not equal to TRUE. At block 504, the localTimeProcessTriggered parameter can be set equal to FALSE, and the SecondsUTCreceivedLast parameter can be set to an INVALID_SECONDS_READING value. The method 500 can end upon or after completion of the procedures of block 504.

At block 506, in response to a determination that the validUTCtimeReceived parameter value is equal to TRUE, the processing device 202 can increment the calibrationTicksCount by one. At block 508, the processing device 202 can determine whether a two-part condition (SecondsUTC is not equal to SecondsUTCreceivedLast AND SecondsUTCreceivedLast is not equal to INVALID_SECONDS_READING) is satisfied. For example, the processing device 202 can determine whether the most-recently received SecondsUTC parameter value is different from the previously received (such as immediately preceding) SecondsUTC parameter value, which is the SecondsUTCreceivedLast parameter value. In many cases, the determination result may indicate no change (not different) because 1 second includes 200 timer interrupt intervals at 5 milliseconds, so a change may be expected once per 200 iterations. The two-part condition can be satisfied when the SecondsUTC parameter value is not equal to the SecondsUTCreceivedLast parameter value and the SecondsUTCreceivedLast parameter value is not equal to the INVALID_SECONDS_READING value. The method 500 can proceed to block 510 based on a determination that the two-part condition is satisfied or to block 518 based on a determination that the two-part condition is not satisfied.

At block 510, the processing device 202 can determine whether the localTimeProcessTriggered parameter value is equal to FALSE. For example, a FALSE value here can indicate that the local clock calibration and calculation have not yet been triggered. The method 500 can proceed to block 514 based on a determination that the localTimeProcessTriggered parameter value is equal to FALSE or proceed to block 516 based on a determination that the localTimeProcessTriggered parameter value is not equal to FALSE. At block 514, the processing device 202 can set the localTimeProcessTriggered parameter value equal to TRUE, set calibrationTicksCount parameter value equal to zero, and set the calibrationSecondsCount parameter value equal to zero. Subsequently, at block 518, the processing device 202 can set the SecondsUTCreceivedLast parameter value equal to the SecondsUTC parameter value. The method 500 can end upon or after completion of the procedures of block 518.

At block 516, the processing device 202 can increment the calibrationSecondsCount by one. Subsequently, at block 512, the processing device 202 can determine that the calibrationSecondsCount parameter value is equal to a multiple of CALIBRATION_NVM_WRITE_THRESHOLD threshold value, and the method 500 can proceed to block 520 based on this determination. The method 500 proceeds to block 518 based on a determination that the calibrationSecondsCount parameter value is not equal to a multiple of CALIBRATION_NVM_WRITE_THRESHOLD threshold value.

At block 520, the processing device 202 can write the calibrationTicksCount and the calibrationSecondsCount parameter values into NVM 560. As part of the method 500, the processing device 202 can perform a RestartLocalUTCclock subprocess 522, which can be the same as or similar to the method 800 of FIG. 8 as described below. After completion of the RestartLocalUTCclock subprocess 522, the method proceeds to block 518, where the processing device 202 can set the SecondsUTCreceivedLast parameter value equal to the SecondsUTC parameter value. The method 500 can end upon or after completion of the procedures of block 518.

Although FIG. 5 illustrates one example of a local clock calibration method 500, various changes may be made to FIG. 5. For example, while shown as a series of steps, various steps in FIG. 5 could overlap, occur in parallel, occur in a different order, or occur any number of times.

FIG. 6 illustrates a local UTC time calculation method 600 according to this disclosure. The local UTC time calculation method 600 can be performed to calculate values for parameters used for defining the local UTC clock time. For ease of explanation, the local UTC time calculation method 600 will be described as performed using the computing device or system 200 of FIG. 2 within the aircraft 100 of FIG. 1. However, the local UTC time calculation method 600 may be performed using any other suitable device(s) or system(s).

The parameters used in the method 600 can be used for local UTC clock time calculation and may include the entirety of the parameters of Table 5, the SecondsUTC parameter from Table 2, and the parameters shown below in Table 8 below. Definitions of these parameters are described further below.

TABLE 8
Types of values stored in parameters associated
with local UTC clock time calculation

| Parameter Name | Type of Value |
|---|---|
| ElapsedSeconds | Numerical |
| LocalUTCtime | See Table 3 |
| UTC time | See Table 7 |

The ticksCount parameter can denote accumulated system ticks since the start of the local UTC clock. The elapsedSeconds parameter can denote elapsed seconds since the start/restart of the local UTC clock. The localUTCclockStarted parameter can be a flag to indicate whether the local UTC clock has started, such as when the localUTCclockStarted parameter is set to FALSE at system startup and is set to TRUE after local time processing is triggered. The SecondsUTClocalStart parameter can denote a standard UTC time seconds reading at the start of the local UTC clock. For precision, the local UTC clock can start at sensing the first received UTC seconds reading change after the UTC time service starts. At the start/restart of the local UTC clock, the ticksCount parameter can be set to zero, the local UTC time elements (also listed in Table 6) can be set equal to the corresponding received UTC time elements, and the SecondsUTClocalStart parameter value can be set to equal the SecondsUTC parameter value.

At block 610, the processing device 202 can determine whether the localUTCclockStarted parameter value is equal to TRUE. At block 620, in response to a determination that the localUTCclockStarted parameter value is not equal to TRUE, the processing device 202 can determine whether the localTimeProcessTriggered parameter value is equal to TRUE. The method 600 can end in response to a determination that the localTimeProcessTriggered parameter value is not equal to TRUE. At block 630, in response to a determination that the localTimeProcessTriggered parameter value is equal to TRUE, the processing device 202 can set the local UTC time to the received value of the standard UTC time and set SecondsUTClocalStart parameter value equal to the SecondsUTC parameter value. At block 640, the processing device 202 can set localUTCclockStarted parameter value equal to TRUE and set the ticksCount parameter value equal to zero. The method 600 can end upon or after completion of the procedures of block 640.

At block 650, in response to a determination that the localUTCclockStarted parameter value is equal to TRUE, the ticksCount parameter value can be incremented by one. At block 660, the elapsedSeconds parameter value can be set to a value defined as the accumulated system ticks divided by the calibrated system ticks count per second as shown in Equation (1).

$$\frac{( ticksCount \times calibratedSecondsCount )}{calibratedTicksCount} \qquad ( 1 )$$

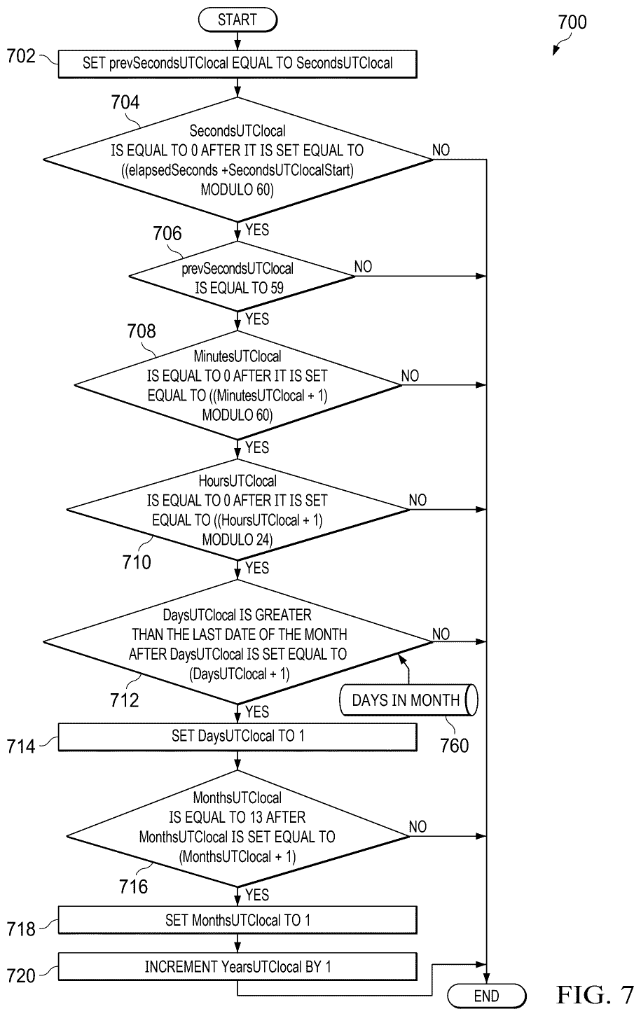

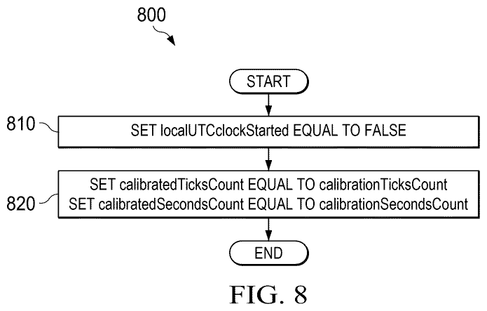

Upon or after completion of the procedures of block 660, the processing device 202 can perform a SetLocalUTCtime subprocess 670 described further below as the method 700 of FIG. 7. At block 680, the processing device 202 can check whether the validUTCtimeReceived parameter value is equal to FALSE. The method 600 can end in response to a determination that the validUTCtimeReceived parameter value is not equal to FALSE. At block 690, the processing device 202 can set the UTC time equal to the local UTC time in response to a determination that the validUTCtimeReceived parameter value is equal to FALSE.

Although FIG. 6 illustrates one example of a local UTC time calculation method 700, various changes may be made to FIG. 6. For example, while shown as a series of steps, various steps in FIG. 6 could overlap, occur in parallel, occur in a different order, or occur any number of times.

FIG. 7 illustrates an example method 700 for setting the local UTC time according to this disclosure. The method 700 can be performed to set the local UTC time using the calculated values for the parameters defining the local UTC clock time. For ease of explanation, the method 700 will be described as performed using the computing device or system 200 of FIG. 2 within the aircraft 100 of FIG. 1. However, the method 700 may be performed using any other suitable device(s) or system(s). In this example, the method 700 is shown as involving the use of a regular ROM (Read-Only Memory) 760.

As shown in FIG. 7, the ROM 760 can include a preconfigured DaysInMonth array that stores number of days in each month and which can be the set {31, 28, 31, 30, 31, 30, 31, 31, 30, 31, 30, 31}. Days in a month can be obtained from the DaysInMonth array by using the month number minus one as the array access index, where the array access indices start at zero. The number of days in February is set as 28 in the array, which can be used for non-leap years. In the case of a leap year, the year number can be a multiple of 4 (except for year numbers that are divisible by 100 and not by 400), and the number of days in February can be replaced with 29. Further, the local UTC clock can accommodate leap seconds if it is known beforehand. For simplicity, leap second logic is not shown in FIG. 7.

At block 702, the prevSecondsUTClocal parameter value can be set equal to the SecondsUTClocal parameter value. At block 704, the processing device 202 can determine whether a condition is satisfied, where satisfaction of the condition can be defined as the SecondsUTClocal parameter value being equal to zero after the SecondsUTClocal parameter value is set equal to the expression shown in Equation (2).

$$( ( elapsedSeconds + SecondsUTClocalStart ) MODULO 60 ) \qquad ( 2 )$$

If the condition is satisfied, the method 700 can proceed to block 706. Otherwise, if the condition is not satisfied, the method 700 can end.

At block 706, the processing device 202 can determine whether a condition is satisfied, where satisfaction of the condition can be defined as the prevSecondsUTClocal parameter value being equal to 59. If the condition is satisfied, the method 700 can proceed to block 708. Otherwise, if the condition is not satisfied, the method 700 can end. At block 708, the processing device 202 can determine whether a condition is satisfied, where satisfaction of the condition can be defined as the MinutesUTClocal parameter value being equal to zero after the MinutesUTClocal parameter value is set equal to the expression shown in Equation (3).

$$( ( MinutesUTClocal + 1 ) MODULO 60 ) \qquad ( 3 )$$

If the condition is satisfied, the method 700 can proceed to block 710. Otherwise, if the condition is not satisfied, the method 700 can end.

At block 710, the processing device 202 can determine whether a condition is satisfied, where satisfaction of the condition can be defined as the HoursUTClocal parameter value being equal to zero after the HoursUTClocal parameter value is set equal to the expression shown in Equation (4).

$$( ( HoursUTClocal + 1 ) MODULO 24 ) \qquad ( 4 )$$

If the condition is satisfied, the method 700 can proceed to block 712. Otherwise, if the condition is not satisfied, the method 700 can end.

At block 712, the processing device 202 can determine whether a condition is satisfied, where satisfaction of the condition can be defined as the DaysUTClocal parameter value being greater than the last date of the month after the DaysUTClocal parameter value is set equal (DaysUTClocal+1). The DaysInMonth array stored in the ROM 760 can be accessed to identify last date of the current month. If the condition is satisfied, the method 700 can proceed to block 714. Otherwise, if the condition is not satisfied, the method 700 can end.

At block 714, the DaysUTClocal parameter value can be set to one. At block 716, the processing device 202 can determine whether a condition is satisfied, where satisfaction of the condition can be defined as the MonthsUTClocal parameter value being equal to 13 after the MonthsUTClocal parameter value is set equal (MonthsUTClocal+1). If the condition is satisfied, the method 700 can proceed to block 718. Otherwise, if the condition is not satisfied, the method 700 can end. At block 718, the MonthsUTClocal parameter value can be set to one. At block 720, the YearsUTClocal parameter value can be incremented by one.

Although FIG. 7 illustrates one example of a method 700 for setting the local UTC time, various changes may be made to FIG. 7. For example, while shown as a series of steps, various steps in FIG. 7 could overlap, occur in parallel, occur in a different order, or occur any number of times.

FIG. 8 illustrates an example method 800 for restarting the local UTC time according to this disclosure. For ease of explanation, the method 800 will be described as performed using the computing device or system 200 of FIG. 2 within the aircraft 100 of FIG. 1. However, the method 800 may be performed using any other suitable device(s) or system(s). In some cases, the method 800 can represent or form a part of the RestartLocalUTCclock subprocess 622 shown in FIG. 5.

At block 810, the localUTCclockStarted parameter value can be set to FALSE to clear the local UTC clock restart flag. A fresh calibration data pair may be used in the local UTC time calculation. At block 820, the calibratedTicksCount parameter value can be set equal to the calibrationTicksCount parameter value, and the calibratedSecondsCount parameter value can be set equal to calibrationSecondsCount parameter value. Note that now the calibratedTicksCount and calibratedSecondsCount parameters store the fresh calibrated data pair values, and in comparison, calibrationTicksCount and calibrationSecondsCount store the live calibrating data pair values.

Although FIG. 8 illustrates one example of a method 800 for restarting the local UTC time, various changes may be made to FIG. 8. For example, while shown as a series of steps, various steps in FIG. 8 could overlap, occur in parallel, occur in a different order, or occur any number of times.

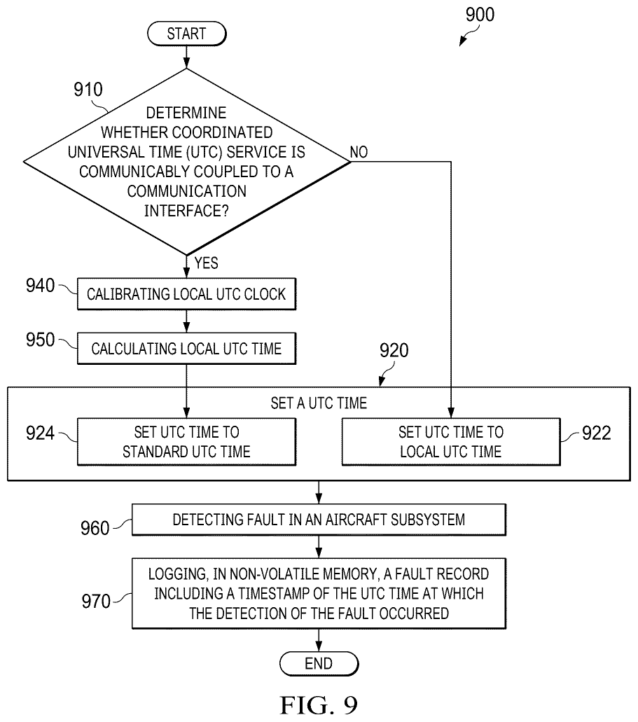

FIG. 9 illustrates an example method 900 for implementing compensation for UTC time service disruption to extend time service according to this disclosure. For ease of explanation, the method 900 will be described as performed using the computing device or system 200 of FIG. 2 within the aircraft 100 of FIG. 1. However, the method 900 may be performed using any other suitable device(s) or system(s).

At block 910, the processing device 202 can determine whether a UTC time service is communicatively coupled to a communication interface, such as communications unit 206 of an aircraft subsystem. The procedure of block 910 can include or be similar to the procedures of block 310 of FIG. 3 or block 410 of FIG. 4.

At block 920, the processing device 202 can set a UTC time, which includes a set of UTC time parameters listed in Table 7, used by the computing device or system 200. The UTC time can be set to (i) a standard UTC time received from the UTC time service when the UTC service is connected to the communication interface, or (ii) a local UTC time calculated based on an oscillator frequency of a timer mechanism associated with the processing device 202 when the UTC service is disconnected from the communication interface. The processing device 202 can set the UTC time to the local UTC time based on a determination result of whether the UTC time service is communicatively coupled to the communication interface. The procedure of block 920 can include or be similar to the procedures of block 680 and block 690 of FIG. 6.

At block 922, in response to a determination that the UTC time service is disconnected from the communication interface, the processing device 202 can set the UTC time to the local UTC time. The procedure of block 922 can include or be similar to the procedures of block 690 of FIG. 6. In some embodiments, the processing device 202 sets the UTC time to the local UTC time based on a determination that both of the following conditions are satisfied: (i) the UTC time service is disconnected from the communication interface; and (ii) the local UTC clock has started and is running such as when the localUTCclockStarted parameter value is equal to TRUE.

At block 924, in response to a determination that the UTC time service is connected to the communication interface, the processing device 202 can set the UTC time to the standard UTC time received from the UTC time service. The procedure of block 924 can include or be similar to the procedures of block 410 of FIG. 4. In some embodiments, the procedure of block 924 can be executed prior to the procedures of block 940 and block 950.

At block 940, the processing device 202 can calibrate the local UTC clock while the UTC time service is communicatively coupled to the communication interface. The procedure at block 940 can include the method 500 of FIG. 5. To calibrate a local UTC clock, the processing device 202 can count (such as by using the procedure of block 506 of FIG. 5) each tick of a periodic timer interrupt that occurs periodically every timer interrupt interval, where each tick is defined by a number of oscillations of the timer mechanism during the periodic timer interrupt interval; count (such as by using the procedure of block 516 of FIG. 5) each second of standard UTC time during the counting of the system ticks until seconds counted satisfies a time threshold (such as by using the procedure of block 512 of FIG. 5) for writing into NVM; and write a calibration data pair into the NVM. The calibration data pair can include (i) the system ticks counted during the number of seconds elapsed and (ii) the elapsed seconds that satisfied the time threshold. To write a calibration data pair into the NVM, the processing device 202 can use the procedures of block 520 of FIG. 5 and subsequently the procedure of block 920 of FIG. 8.

At block 950, the processing device 202 can calculate the local UTC time. The calculating of the local UTC time can be performed using the method 600 of FIG. 6. The calculating of the local UTC time can include starting a local UTC clock (as shown at block 640 of FIG. 6) after confirmation of a triggered local time process (as shown at block 620 of FIG. 6) in response to a determination that the UTC time service is connected to the communication interface (as shown at block 514 of FIG. 5). As part of calculating of the local UTC time, counting (as shown at block 650 of FIG. 6) each tick in response to the periodic timer interrupt can be performed after the start of the local UTC clock. The elapsed seconds after the local UTC clock starts can be determined as an estimated equivalent to the elapsed seconds of standard UTC time based on the ticks counted since the start of the local UTC clock divided by a scale ratio. The scale ratio can represent the calibrated number of system ticks in a second. The scale ratio may be deduced from the previously calibrated data pair of calibratedTicksCount and calibratedSecondsCount. The scale ratio may be calibratedTicksCount divided by calibratedSecondsCount. The elapsed seconds of the local UTC time can be determined using Equation (1) above and the procedure of block 660 of FIG. 6. The calculating of the local UTC time can include counting each elapsed second of the local UTC time since the start of the local UTC clock to update the calculated local UTC time.

At block 960, the processing device 202 can detect a fault of an aircraft system or subsystem. When a fault is detected, a timestamp may be tagged on the fault before the fault is logged in NVM. The timestamp is the received standard UTC time when the UTC time service is CONNECTED (validUTCtime Received is equal to TRUE), otherwise the timestamp is from the local UTC clock if the local clock has started (localUTCclockStarted is equal to TRUE).

At block 970, the processing device 202 can log, into the NVM, a fault record including a timestamp at which the detection of the fault occurred. In a case in which the fault has been detected while the UTC time service is disconnected from the communication interface, logging of a fault record can include a timestamp of the calculated local UTC time.

Although FIG. 9 illustrates one example of a method 900 for implementing compensation for UTC time service disruption to extend the time service, various changes may be made to FIG. 9. For example, while shown as a series of steps, various steps in FIG. 9 could overlap, occur in parallel, occur in a different order, or occur any number of times.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive (HDD), a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable storage device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present disclosure should not be read as implying that any particular element, step, or function is an essential or critical element that must be included in the claim scope. The scope of patented subject matter is defined only by the allowed claims. Moreover, none of the claims invokes 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
determining, by at least one processor, whether a Coordinated Universal Time (UTC) service is communicatively coupled to a communication interface; and
setting a UTC time with (i) a standard UTC time received from the UTC time service or (ii) a local UTC time calculated based on an oscillator frequency of a timer mechanism associated with the at least one processor based on a determination result of whether the UTC time service is communicatively coupled to the communication interface.

2. The method of claim 1, wherein setting the UTC time comprises:
setting the UTC time with the local UTC time in response to a determination that the UTC time service is disconnected from the communication interface.

3. The method of claim 2, wherein setting the UTC time further comprises:
setting the UTC time with the received standard UTC time in response to a determination that the UTC time service is connected to the communication interface.

4. The method of claim 2, further comprising:
in response to a detection of a fault in an aircraft system or subsystem while the UTC time service is disconnected from the communication interface, logging, into a non-volatile memory, a fault record including a timestamp of the local UTC time at which the detection of the fault occurred.

5. The method of claim 1, further comprising:
calibrating a local UTC clock while the UTC time service is communicatively coupled to the communication interface, wherein calibrating the local UTC clock comprises:
counting each tick of a periodic timer interrupt that occurs periodically every timer interrupt interval, each tick defined by a number of oscillations of the timer mechanism during the periodic timer interrupt interval;
counting each second of standard UTC time that elapses during the counting of the ticks until seconds counted satisfies a time threshold for writing into the non-volatile memory; and
writing a calibration data pair into the non-volatile memory;
wherein the calibration data pair includes (i) the ticks counted during the seconds elapsed and (ii) the seconds elapsed that satisfied the time threshold.

6. The method of claim 1, further comprising: calculating the local UTC time, wherein calculating the local UTC time comprises:
starting a local UTC clock in response to a determination that the UTC time service is connected to the communication interface;
after the start of the local UTC clock, counting each tick in response to the periodic timer interrupt;
determining elapsed seconds of the local UTC time as an estimated equivalent to elapsed seconds of standard UTC time based on a count of the ticks counted since the start of the local UTC clock divided by a scale ratio,
wherein the scale ratio represents a calibrated number of ticks in a second, wherein the scale ratio is deduced from a previously calibrated data pair read from a non-volatile memory (NVM) at system startup or a fresh calibrated data pair to write into the NVM at a calibration time; and
counting each elapsed second of the local UTC time since the start of the local UTC clock to update the calculated local UTC time.

7. An electronic device comprising:
a communication interface configured to communicatively couple to a Coordinated Universal Time (UTC) service; and
at least one processor configured to:
determine whether the UTC time service is communicatively coupled to the communication interface; and
set a UTC time with (i) a standard UTC time received from the UTC time service or (ii) a local UTC time calculated based on an oscillator frequency of a timer mechanism associated with the at least one processor based on a determination result of whether the UTC time service is communicatively coupled to the communication interface.

8. The electronic device of claim 7, wherein, to set the UTC time, the at least one processor is configured to:
set the UTC time with the local UTC time in response to a determination that the UTC time service is disconnected from the communication interface.

9. The electronic device of claim 8, wherein, to set the UTC time, the at least one processor is further configured to:
set the UTC time with the received standard UTC time in response to a determination that the UTC time service is connected to the communication interface.

10. The electronic device of claim 8, wherein the at least one processor is further configured to:
in response to a detection of a fault in an aircraft system or subsystem while the UTC time service is disconnected from the communication interface, log, into a non-volatile memory of the electronic device, a fault record including a timestamp of local UTC time at which the detection of the fault occurred.

11. The electronic device of claim 7, wherein:
the at least one processor is further configured to calibrate a local UTC clock while the UTC time service is communicatively coupled to the communication interface;
to calibrate the local UTC clock, the at least one processor is configured to:
count each tick of a periodic timer interrupt that occurs periodically every timer interrupt interval, each tick defined by a number of oscillations of the timer mechanism during the periodic timer interrupt interval;
count each second of standard UTC time that elapses during the counting of the ticks until seconds counted satisfies a time threshold for writing into the non-volatile memory; and
write a calibration data pair into the non-volatile memory; and
the calibration data pair includes (i) the ticks counted during the seconds elapsed and (ii) the seconds elapsed that satisfied the time threshold.

12. The electronic device of claim 7, wherein the at least one processor is further configured to calculate the local UTC time, wherein, to calculate the local UTC time, the at least one processor is configured to:
start a local UTC clock in response to a determination that the UTC time service is connected to the communication interface;
after the start of the local UTC clock, count each tick of in response to the periodic timer interrupt;
determine elapsed seconds of the local UTC time as an estimated equivalent to elapsed seconds of standard UTC time based on a count of the ticks counted since the start of the local UTC clock divided by a scale ratio,
wherein the scale ratio represents a calibrated number of ticks in a second, wherein the scale ratio is deduced from a previously calibrated data pair read from a non-volatile memory (NVM) at system startup or a fresh calibrated data pair to write into the NVM at a calibration time; and
count each elapsed second of the local UTC time since the start of the local UTC clock to update the calculated local UTC time.

13. A non-transitory machine-readable medium including instructions that when executed cause at least one processor to:
determine whether a Coordinated Universal Time (UTC) service is communicatively coupled to a communication interface; and
set a UTC time with (i) a standard UTC time received from the UTC time service or (ii) a local UTC time calculated based on an oscillator frequency of a timer mechanism associated with the at least one processor based on a determination result of whether the UTC time service is communicatively coupled to the communication interface.

14. The non-transitory machine-readable medium of claim 13, wherein the instructions that when executed cause the at least one processor to set the UTC time comprise:
instructions that when executed cause the at least one processor to:
set the UTC time with the local UTC time in response to a determination that the UTC time service is disconnected from the communication interface.

15. The non-transitory machine-readable medium of claim 14, wherein the instructions that when executed cause the at least one processor to set the UTC time comprise:
instructions that when executed cause the at least one processor to: set the UTC time with the received standard UTC time in response to a determination that the UTC time service is connected to the communication interface.

16. The non-transitory machine-readable medium of claim 13, further containing instructions that when executed cause the at least one processor to:
in response to a detection of a fault in an aircraft system or subsystem while the UTC time service is disconnected from the communication interface, log, into a non-volatile memory, a fault record including a timestamp of local UTC time at which the detection of the fault occurred.

17. The non-transitory machine-readable medium of claim 13, further containing instructions that when executed cause the at least one processor to calibrate a local UTC clock while the UTC time service is communicatively coupled to the communication interface;
wherein the instructions that when executed cause the at least one processor to calibrate the local UTC clock comprise instructions that when executed cause the at least one processor to:
count each tick of a periodic timer interrupt that occurs periodically every timer interrupt interval, each tick defined by a number of oscillations of the timer mechanism during the periodic timer interrupt interval;
count each second of standard UTC time during the counting of the ticks until seconds counted satisfies a time threshold for writing into the non-volatile memory; and
write a calibration data pair into the non-volatile memory; and
wherein the calibration data pair includes (i) the ticks counted during the seconds elapsed and (ii) the seconds elapsed that satisfied the time threshold.

18. The non-transitory machine-readable medium of claim 13, further containing instructions that when executed cause the at least one processor to calculate the local UTC time, wherein the instructions that when executed cause the at least one processor to calculate the local UTC time comprise:
instructions that when executed cause the at least one processor to:
start a local UTC clock in response to a determination that the UTC time service is connected to the communication interface;
after the start of the local UTC clock, count each tick of in response to the periodic timer interrupt;
determine elapsed seconds of the local UTC time as an estimated equivalent to elapsed seconds of standard UTC time based on a count of the ticks counted since the start of the local UTC clock divided by a scale ratio,
wherein the scale ratio represents a calibrated number of ticks in a second, wherein the scale ratio is deduced from a previously calibrated data pair read from a non-volatile memory (NVM) at system startup or a fresh calibrated data pair to write into the NVM at a calibration time; and
count each elapsed second of the local UTC time since the start of the local UTC clock to update the calculated local UTC time.
